(19) United States
(12) Patent Application Publication
(10) Pub. No.: US 2013/0215023 A1
(43) Pub. Date: Aug. 22, 2013

(54) INTERACTIVE DIALOG DEVICES AND METHODS FOR AN OPERATOR OF AN AIRCRAFT AND A GUIDANCE SYSTEM OF THE AIRCRAFT

(71) Applicant: AIRBUS OPERATIONS (SAS), (US)

(72) Inventors: Thierry Bourret, Toulouse (FR); Pascale Louise, Toulouse (FR); Claire Ollagnon, Montpellier (FR); Nicolas Chauveau, Montpellier (FR); Sebastien Giuliano, Toulouse (FR); Sebastien Drieux, Toulouse (FR)

(21) Appl. No.: 13/834,401

(22) Filed: Mar. 15, 2013

Related U.S. Application Data
(63) Continuation-in-part of application No. 13/687,729, filed on Nov. 28, 2012.

(30) Foreign Application Priority Data
Nov. 29, 2011 (FR) 11 60884

(51) Int. Cl. G06F 3/01

(52) U.S. Cl. CPC G06F 3/01
USPC 345/157; 345/156; 345/173

(57) ABSTRACT

Interactive dialog devices and methods can be installed on an aircraft for communication between an operator of the aircraft and a guidance system of the aircraft. A dialog device can include a global screen configured for displaying guidance information related to each of a navigation display, a vertical display, and a primary flight display. The global screen can include at least one graphic object which is produced in the form of an interaction element which represents a control feature that can be grasped and moved by an operator to modify a value of at least one guidance target of the guidance system associated with one or more of the navigation display, the vertical display, or the primary flight display.

### CROSS-REFERENCE TO RELATED APPLICATIONS

This application is a continuation-in-part application from and claims priority to co-pending U.S. patent application Ser. No. 13/687,729 filed Nov. 28, 2012, which relates and claims priority to French Patent Application No. 11 60884 filed Nov. 29, 2011, the entire disclosures of which are incorporated by reference herein.

### TECHNICAL FIELD

The present subject matter relates generally to dialog devices and methods for an aircraft, for example a transport airplane, enabling a dialog between an operator of the aircraft, in particular a pilot, and a guidance system of the aircraft.

### BACKGROUND

Airplanes that are provided with a guidance system, either a flight director that computes piloting targets on the basis of guidance targets or an automatic piloting system that makes it possible to follow guidance targets automatically, are typically provided with an item of equipment, for example one called FCU (Flight Control Unit) on airplanes of the AIRBUS type or one called MCP (Mode Control Panel) on airplanes of the BOEING type, that enables a pilot of the airplane to enter guidance targets into the guidance system. Generally, the pilot chooses a guidance target, then he or she controls the engagement (activation) of the associated guidance mode, so that it takes into account either the value entered (in a so-called “selected” mode), or a value computed by the system according to various criteria (in a so-called “managed” mode).

More particularly, the pilot can, with respect to the speed axis, enter a speed (i.e., calibrated airspeed CAS) or Mach target or give control to the system so as to use a speed or Mach target computed on the basis of certain criteria. On the lateral axis, the pilot can enter a heading (HEADING) or route (TRACK) target or give control to the system so as to use the route from the predefined flight plan. On the vertical axis, the pilot can provide a level, follow an axis (e.g., an approach axis), enter an altitude target, indicate how to reach this altitude target by observing a vertical speed or a gradient, by optimizing the climb or descent time while observing an air speed, or by observing a geometrical vertical profile defined by the system according to certain criteria. These targets are taken into account by the guidance system, either directly as soon as their value is modified if the associated mode is active, or after validation (i.e., engagement of the associated mode) in the case where another guidance mode is initially engaged. In the latter case, the target is to be preset before its validation.

For each selection of a target to be reached or to be maintained there is a corresponding guidance mode of the airplane. There is one mode engaged for each axis (speed, lateral, vertical) exclusively. As an illustration, on the lateral axis, a heading mode or route mode can be captured or maintained, a trajectory of the flight plan mode can be joined or maintained, or an approach axis on a horizontal plane mode can be captured or maintained. On the vertical axis, an altitude mode can be captured or maintained, a desired altitude can be reached (climb or descent) while observing an air speed mode, a climb or descent can be performed while observing a vertical speed or a gradient, a climb or descent can be performed while observing a geometrical profile or altitude constraints mode, or a vertical plane mode can be used to capture or maintain the approach axis.

A synthetic summary of the behavior of the guidance system (flight director or automatic piloting system, associated or not with an automatic thrust control) is produced, generally, on the screens displaying the primary flight parameters, of PFD (Primary Flight Display) type, on a panel of FMA (Flight Mode Annunciator) type. This synthetic summary reviews, generally, the guidance modes that are engaged (active) on each axis (speed, lateral, vertical), as well as the guidance modes that are armed, that is to say those which have been requested by the pilot and which will be engaged automatically when conditions for engaging the mode are satisfied. As an example, outside the trajectory of the flight plan, in maintain heading mode converging toward the trajectory of the flight plan with the join or maintain the trajectory of the flight plan mode armed, the latter mode is engaged automatically on approaching the flight plan.

In most airplanes with two pilots, the control unit of the guidance system is situated in the center of the cockpit (above the screens showing the flight parameters) so that both pilots can access it. This control unit, for example of FCU type, makes it possible to select guidance targets, to engage the modes associated with a guidance target (render the mode active), or to request the arming of the mode, and to change reference (for example heading rather than route) for a guidance target.

The task of the pilot responsible for the guidance of the airplane is to select the guidance targets and modes. Currently, he or she performs this task through the dedicated control unit (FCU or MCP) which is located between the two pilots, then he or she has to check the selection of his or her targets (values) on the primary flight screen which is located facing him or her (PFD, standing for Primary Flight Display) and/or on the navigation screens (ND, standing for Navigation Display in the lateral plane; VD, standing for Vertical Display in the vertical plane). Then, the guidance is monitored on these screens which indicate the behavior of the guidance. For instance, the guidance can be a summary of the behavior via the synthesis of the modes that are armed and engaged (e.g., shown on an FMA panel), a display of guidance targets (e.g., speed CAS, heading/route, altitude, vertical speed/gradient) and deviations in relation to the current parameters of the airplane (e.g., shown on a PFD screen), or margins in relation to the limits, such as a margin in relation to the minimum operational speed and stall speed (e.g., shown on a PFD screen).

This standard solution presents drawbacks, however, such as the pilot having to select the guidance targets and modes in one place (control unit FCU), then check and monitor the behavior of the airplane in another place (on the playback screens). This involves visual toing and froing and a dispersion of the guidance elements between the control and the display of the behavior of the system. In addition, the control unit is a physical item of equipment that is costly and difficult to modify (because it is of hardware type), and this control unit is bulky in the cockpit.

### SUMMARY

The present subject matter provides novel dialog devices and methods for an operator, notably a pilot, of an aircraft and a guidance system of the aircraft, which makes it possible to remedy the above-mentioned drawbacks. To this end, and according to the subject matter disclosed herein, the dialog device can be installed on the aircraft and can comprise a global screen configured for displaying guidance information related to each of a navigation display, a vertical display, and a primary flight display. The global screen can comprise at least one graphic object that can be produced in the form of an interaction element that can represent a control feature that can be grasped and moved along a path, such as a curve, by an operator so as to modify a value of at least one guidance target of the guidance system. Thus, by virtue of the present subject matter, there is on the screen (e.g., PFD, ND, or VD type) at least one interaction element associated with a guidance target of the guidance system and that not only makes it possible to restore the value of this guidance target with which it is associated, but also enables an operator to modify this value on the screen. In this way, the control and the monitoring are combined or co-located.

The present subject matter can be applied to any guidance target used by a guidance system and in particular to the following guidance targets: speed/Mach, heading/route, altitude, vertical speed/gradient. An interaction function (direct) can thus be obtained on a screen (which was hitherto dedicated only to the display of the flight parameters and guidance), through an interaction element (namely a graphic object allowing an interaction) associated with a guidance target.

This interaction element can be grasped or selected and moved by an operator along a curve (e.g., on a scale, which can appear dynamically and contextually when modifying a target) so as to modify the associated guidance target. By way of example, the present subject matter can make it possible to grasp an interaction element indicating a heading target, move it along a heading scale (a heading rose for example) to modify the heading target so that the new heading target is taken into account by the guidance system of the aircraft. The path, such as a curve, which is predefined can be a scale of values displayed by default or an independent path or curve on which a scale of values can appear dynamically and contextually.

A dialog device according to the present subject matter, of interactive type, thus makes it possible for the pilot to select guidance targets (as well as guidance modes, as specified below) in the same place (screen) where he or she can check and monitor the behavior of the aircraft. This arrangement avoids the visual toing and froing and a dispersion of the guidance elements that exists on the standard dialog devices. The dialog device can further make it possible, in circumstances specified below, to do away with a control unit (e.g., FCU type), which is an item of equipment that is costly, difficult to modify and bulky.

In one particular configuration, the interaction element can comprise a plurality of states which allow different actions to be implemented. In this case, advantageously, the interaction element can be movable to any of a plurality states which allow at least some of the following different actions to be implemented: modifying a guidance target, called selected, which is directly applied by the guidance system; modifying a preset guidance target, which will be applied by the guidance system after validation; engaging a capture or maintain mode for a selected guidance target; and/or engaging a capture or maintain mode for a computed guidance target (called “managed”). Furthermore, advantageously the transition from one state to another of the interaction element can be generated by a corresponding movement thereof.

Moreover, in one configuration, the dialog device can comprise a plurality of interaction elements, each of which is intended for a given guidance target (speed/Mach, heading/route, altitude, vertical speed/gradient) of the guidance system. The use of a plurality of interaction elements, namely an interaction element for each guidance target, on the screens dedicated to the playback of the flight parameters and of the guidance (PFD, ND, VD) makes it possible to directly implement on these screens all the functions of a standard physical control unit, for example of FCU type, and therefore to do away with such a control unit, which represents a significant saving in particular in terms of cost, weight and bulk.

In one particular configuration, the global screen can generate a dynamic visual feedback on a predicted trajectory associated with the guidance target, which makes it possible to have directly on the same screen both a way for selecting the guidance target, for displaying its value, and an indication of the effect generated on the trajectory of the aircraft. This embodiment is particularly advantageous operationally, since the pilot can immediately interpret the impact of his or her guidance target modifications on the trajectory, and can do so without the need for any visual toing and froing between a control panel and a display screen. Furthermore, in this case, advantageously the screen can automatically display at least one characteristic point of the predicted trajectory, and the interaction element is capable of acting on the characteristic point(s), thus displayed, of the predicted trajectory to modify them.

In a first embodiment of a dialog device, the screen can be a touch screen, and a graphic object can be controlled by a direct contact (e.g., finger contact) on the part of the operator on this touch screen. Furthermore, in a second embodiment, the dialog device can comprise, in addition to the screen, a control device, such as a trackball or a touchpad in particular (of the multi-touch type or not), that can be linked to the screen and that can enable an operator to control the movement of a cursor on the screen, intended to act on the interaction element provided.

The present subject matter also relates to a guidance system of an aircraft, namely a flight director or an automatic piloting system which may be associated with an automatic thrust system, the automatic piloting system comprising a dialog device such as that mentioned above, to enable a dialog between the guidance system and an operator, notably a pilot, of the aircraft. The present subject matter also relates to an aircraft, in particular a transport airplane, which is equipped with such a dialog device and/or with such a guidance system.

These and other objects of the present disclosure as can become apparent from the disclosure herein are achieved, at least in whole or in part, by the subject matter disclosed herein.

### BRIEF DESCRIPTION OF THE DRAWINGS

A full and enabling disclosure of the present subject matter including the best mode thereof to one of ordinary skill in the art is set forth more particularly in the remainder of the specification, including reference to the accompanying figures, in which:

FIG. 1 is a block diagram of a dialog device according to the present subject matter;

FIGS. 2 to 8 schematically illustrate devices or systems and methods for interacting with a navigation display according to embodiments of the presently disclosed subject matter;

FIGS. 9 to 16 schematically illustrate devices and methods for interacting with a vertical display type screen according to embodiments of the presently disclosed subject matter;

FIG. 17 schematically illustrates devices and methods for interacting with a primary flight display type screen according to an embodiment of the presently disclosed subject matter;

FIGS. 18, 19A, and 19B schematically illustrate devices and methods for interacting with a global screen according to embodiments of the presently disclosed subject matter; and

FIGS. 20A to 201 schematically illustrate devices and methods for adjusting the position of an interaction element according to embodiments of the presently disclosed subject matter.

### DETAILED DESCRIPTION

The present subject matter provides devices, systems, and methods that enable a dialog between an operator of an aircraft, in particular a pilot, and a guidance system of the aircraft. In one aspect schematically represented in FIG. 1, for example, the present subject matter provides a dialog device generally designated 1 that can be installed on an aircraft, in particular a transport airplane. In particular, dialog device 1 can be arranged in the cockpit of the aircraft. This dialog device 1 can be configured to allow a dialog between at least one operator of the aircraft (e.g., a pilot) and a standard guidance system of the aircraft.

For this, the dialog device 1 that can be installed on the aircraft can comprise a display system 2 that can comprise at least one screen 3 capable of displaying guidance information of the guidance system 4. The dialog device 1 may comprise one or more screen 3. Specifically, for example, the dialog device 1 can comprise at least one of a piloting screen of Primary Flight Display (PFD) type, a navigation screen of Navigation Display (ND) type in relation to the lateral plane, and/or a navigation screen of Vertical Display (VD) type in relation to the vertical plane.

According to the present subject matter, the screen 3 can comprise at least one graphic object that can be produced in the form of an interaction element 8. This interaction element 8 can be associated with at least one guidance target of the guidance system 4 and can represent, on the one hand, a display element that indicates the value of this guidance target of the guidance system 4, in conjunction with a scale of values and, on the other hand, a control feature that can be grasped and moved along a curve by an operator, in particular the pilot of the aircraft, so as to modify the value of the guidance target (of the guidance system 4).

To do this, the display system 2 comprising the screen 3 can be linked such as via a link 5 to guidance components 4A, 4B, and 4C of the guidance system 4, so as to be able to provide a communication of information between the two assemblies. The guidance system 4 may comprise, as guidance components, a standard flight director 4A, that can compute piloting targets on the basis of guidance targets, and/or a standard automatic piloting system 4B, which makes it possible to follow guidance targets automatically, and/or a standard automatic thrust system 4C which makes it possible to manage the engines thrust automatically. Thus, by virtue of the dialog device 1 according to the present subject matter, the operator has on the screen 3 at least one interaction element 8 that can be associated with a guidance target of the guidance system 4 and that not only makes it possible to restore the value of this guidance target with which it is associated, but also enables this value to be modified on the screen 3.

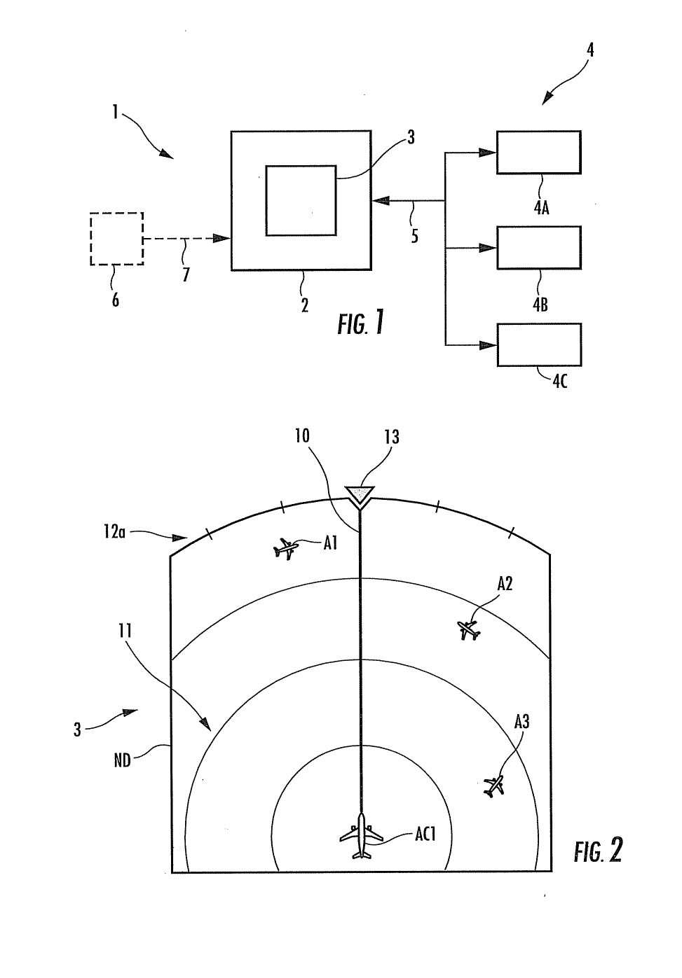

A dialog device 1 according to the present subject matter therefore allows a direct interaction on a screen 3 (which was hitherto dedicated solely to the display of the flight parameters and guidance), through an interaction element 8 (namely a graphic object allowing an interaction) associated with a guidance target. For example, in a first configuration of the dialog device, the screen 3 can be a touch screen, as represented in FIGS. 2 to 17, and a graphic object can be controlled by the operator by a direct contact on the touch screen 3, such as by a finger contact on the part of the operator, a finger 9 of whom is partially represented in some of these figures.

Furthermore, in a second configuration, dialog device 1 can comprise a control device 6, represented by broken lines in FIG. 1 to show that they correspond to a possible variant, where control device 6 can be linked to the screen 3 (e.g., by a standard link 7 of wired or electromagnetic wave type) and can be actuated manually by an operator so as to control the movement of a standard cursor (not represented) on the screen 3, intended to act on the interaction element 8. Control device 6 may notably comprise a trackball, a computer mouse, and/or a touchpad (of multi-touch type or not). In yet a further configuration, control device 6 can comprise an eye-tracker combined with a second control device (e.g., a touch pad, a knob, or any similar devices such as a wheel, a track-ball, or a mouse), the second control device being enabled to interact with an object (e.g., the interaction element) that can be selected through the eye-tracker. The eye-tracker could be installed on the cockpit panel or integrated inside glasses worn by the pilot.

The eye tracking system/software can be configured to detect the focus of the pilot's eyes even if there are perturbations. Therefore, the eye tracker can be calibrated so that a pilot has only to look at a large zone around the interaction element that the pilot wants to select, thus limiting the accuracy required for selection. In this way, control device 6 can be configured such that the interaction element can be selected only if the pilot looks at the large zone during a predetermined time (e.g., 1 second).

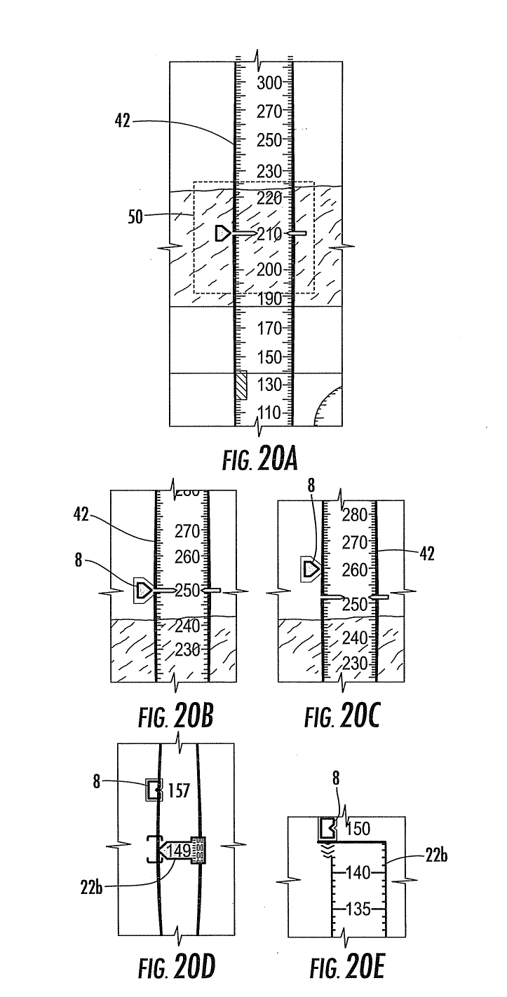

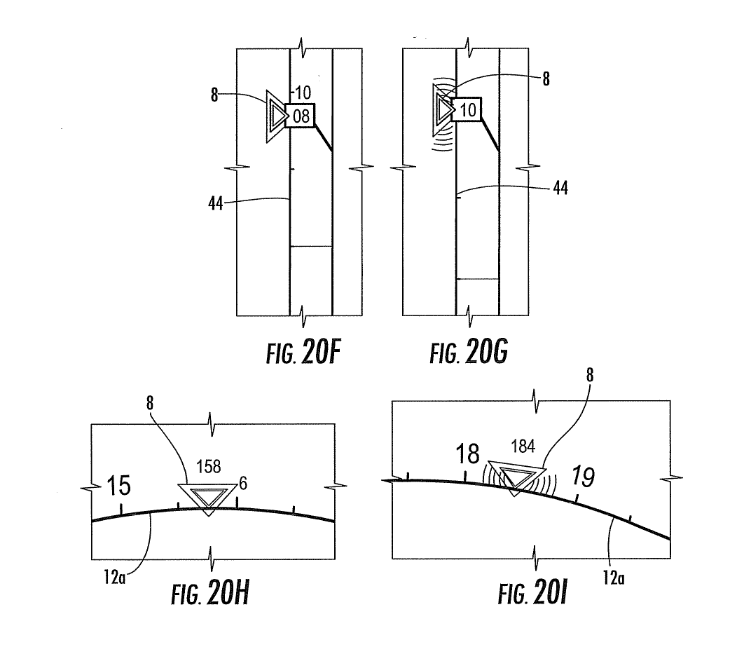

Referring to FIG. 20a, for example, a focus zone 50 can be the zone in which the estimated eye position trigger interaction element appears to become modifiable. The exact size and shape is shown merely as an example and without limitation. When an interaction element 8 is selected, its color or its shape can change to inform the pilot that the interaction element 8 can be modified. Once the interaction element 8 is selected, it can be configured to stay selected for a predetermined time period (e.g., around 1 second). Then, if the second control device is used to modify the position of interaction element 8, interaction element 8 can stay locked in a selectable state until the second control device is no longer used and the pilot looks during a predetermined time (e.g., 1 or 2 seconds) at another large zone. This position modification could, for example, comprise touching the pad with one finger, or grabbing a knob in a cockpit panel. The lock status can be maintained as long as the finger is held on the pad or the knob is maintained grabbed or a specific validation or cancel action is performed though a dedicated device as described below. This can advantageously allow the pilot to look anywhere else while the interaction element 8 remains selected.

If it is desired to change which guidance target can be modified, the pilot's focus can be shifted from interaction element 8 to a second interaction element. After the second interaction element is selected, a specific gesture could be performed using the second control device to confirm the selection. This gesture can be, for example, maintaining the finger on the touch pad during a predetermined time, touching the pad with a second finger, acting with any handles that could be present in the cockpit, and/or pushing/pulling on any knobs in the cockpit panel. This selection confirmation can prevent perturbations in case the eyes of the pilot cannot stay focused or directed for a period of time.

Regardless of the specific form, control device 6 can be configured to allow an operator to select or grasp and move the interaction element 8 such as on a display along a predefined path such as a curved path or straight path (on a scale for example, which may appear dynamically and contextually when modifying a target) so as to modify the associated guidance target. The path such as a curve for example may be a scale of values that can be displayed by default, as represented in FIGS. 2 to 16, or an independent path on which a scale of values may appear dynamically and contextually.

As an illustration, in FIGS. 2 to 8, the screen 3 can be a navigation screen of Navigation Display (ND) type relating to the lateral plane. Specifically, FIGS. 2 to 8 show the current position AC1 of an aircraft equipped with the device 1, the current positions of surrounding aircraft A1, A2, A3 relative to the current position AC1, a distance scale 11 (in relation to the current position AC1), a first heading scale 12a (e.g., a heading rose) with the value of the current heading being indicated on first the heading scale 12a by a symbol 13, and a continuous line plot 10 which illustrates the lateral trajectory followed by the aircraft. FIGS. 2 to 6 illustrate different successive situations when modifying a guidance target of the guidance system 4, in this case a heading target.

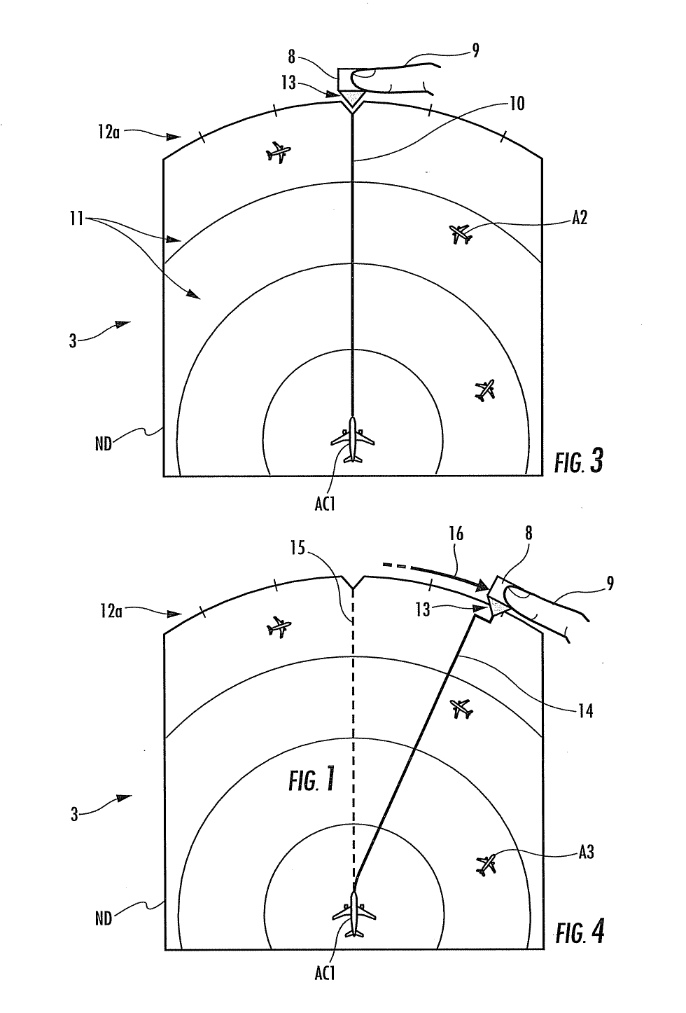

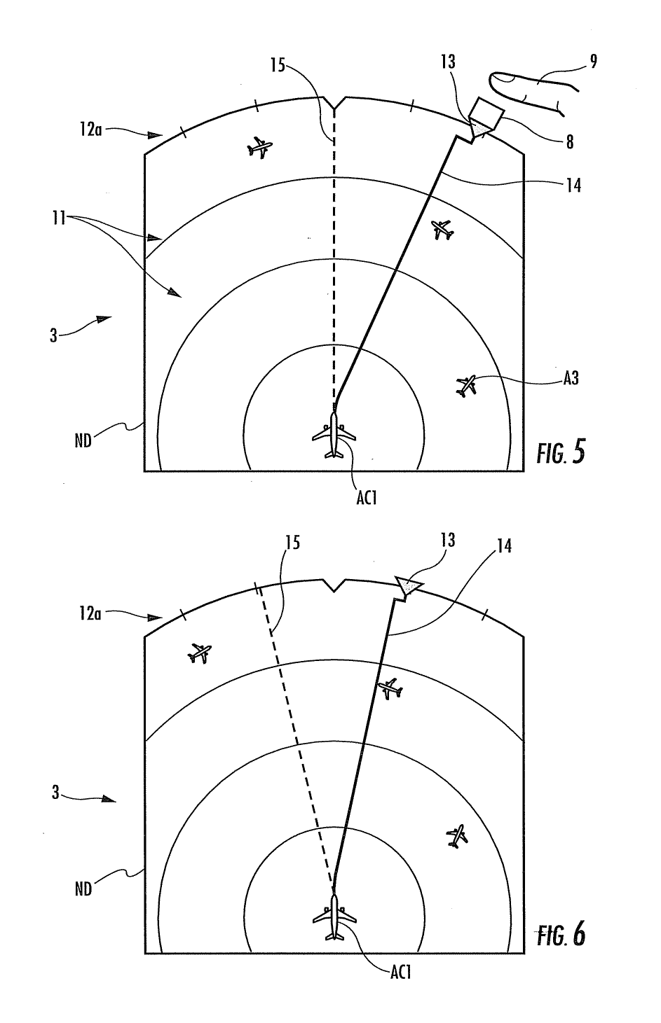

More specifically, FIG. 2 illustrates the initial situation before a modification. In FIG. 3, an operator can place a finger 9 on a graphic object of the screen ND, this finger contact with the screen ND causing an interaction element 8 to appear, intended to modify the heading target of the aircraft. The operator can then move the interaction element 8 with his or her finger 9, as illustrated by an arrow 16 in FIG. 4 so as to modify the heading value. A first broken line plot 15 which illustrates the lateral trajectory according to the flight plan appears, and a second plot 14 which indicates a predicted lateral trajectory follows the interaction element 8, with second and first plots 14 and 15 illustrating trajectory portions in the lateral plane. As shown in FIG. 5, the operator can release his or her finger 9, the modification can be taken into account by the guidance system 4, and the new heading can be illustrated on the first heading scale 12a by the symbol 13. The aircraft can then progressively modify its heading (as illustrated in FIG. 6) to achieve this new heading.

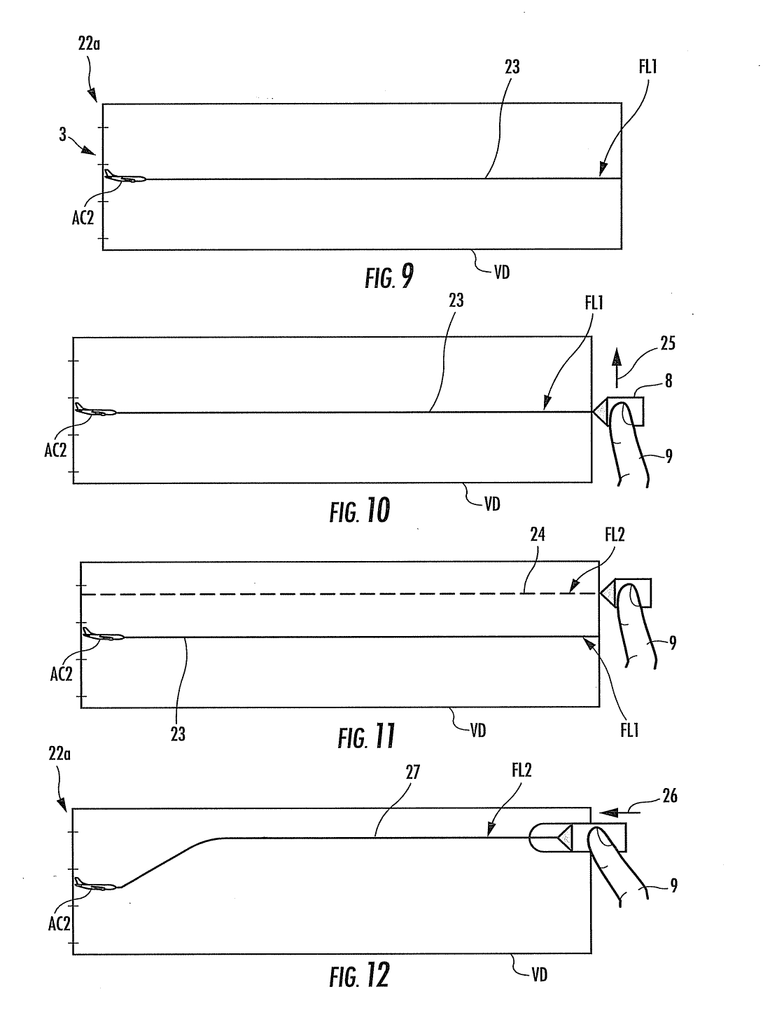

Moreover, by way of illustration, in FIGS. 9 to 16, the screen 3 can be a navigation screen of Vertical Display (VD) type relating to the vertical plane. FIGS. 9 to 16 notably show the current position AC2 of an aircraft equipped with the device 1 and a first altitude scale 22a. FIGS. 9 and 12 illustrate successive situations when modifying a guidance target of the guidance system 4, in this case an altitude target (or flight level), the aircraft can initially be in a maintain altitude mode. More specifically, in FIG. 9, the aircraft can follow a vertical trajectory (plot 23) making it possible to maintain a flight level FL1. As shown in FIG. 10, an operator can bring a finger 9 over a graphic object so as to cause an interaction element 8 to appear, making it possible to modify an altitude target. The operator can move the interaction element 8, as illustrated by an arrow 25, so as to preset a new altitude target. This modification can be made in a presetting mode so that the flight level to be set (which is represented by a broken line plot 24 in FIG. 11) can be highlighted by a different color from that of the plot 23. For example, the plot 23 can be green, and the plot 24 can be yellow. The new altitude target (i.e., to reach a flight level FL2 according to a trajectory 27) can be taken into account by the guidance system 4 after the engagement of a climb mode (maintain speed CAS without altitude constraint), which is controlled by an appropriate movement (illustrated by an arrow 26) of the interaction element 8, as shown in FIG. 12.

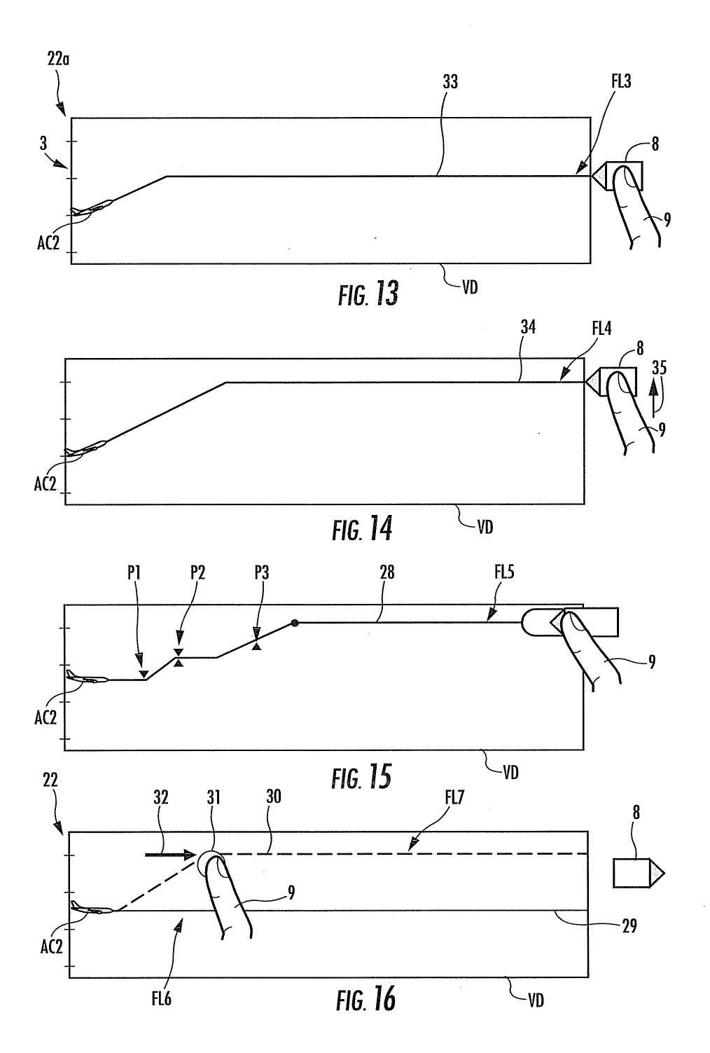

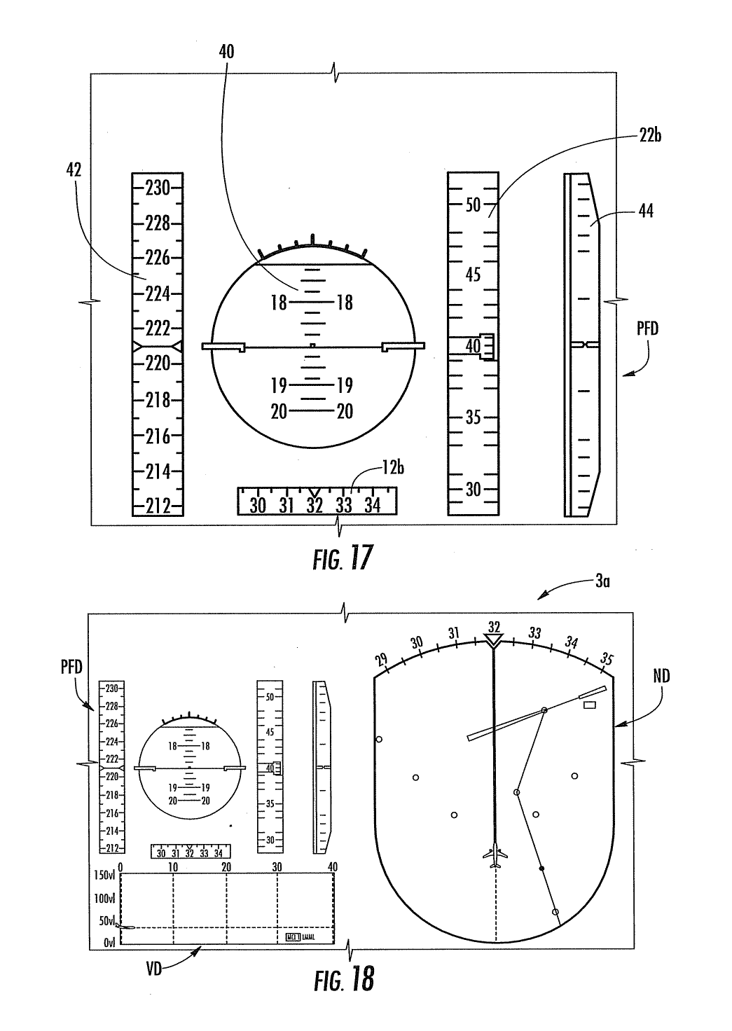

FIGS. 13 and 14 also illustrate successive situations when modifying a guidance target of the guidance system 4, in this case an altitude target (or flight level), but in this case the aircraft is initially (not in a maintain altitude mode) but in a climb to a flight level FL3 mode. More specifically, in FIG. 13, the aircraft can follow a vertical trajectory (plot 33) making it possible to reach a flight level FL3. Furthermore, as shown in FIG. 13, an operator can bring a finger 9 over a graphic object so as to cause an interaction element 8 to appear making it possible to modify an altitude target. This interaction element 8 can appear directly at the level of the flight level FL3, and as shown in FIG. 14, the operator can move the interaction element 8, as illustrated by an arrow 35, so as to make a modification to the altitude target which can, in this case, be immediately taken into account by the guidance system 4 (to reach a flight level FL4 according to a trajectory 34).

It is also possible to implement a climb mode to a target altitude by observing a particular constraint, for example an altitude or geometrical profile constraint. As an illustration, in the example of FIG. 15, to reach a flight level FL5, the vertical trajectory 28 can be configured to comply with a plurality of altitude constraints, illustrated respectively by symbols P1, P2 and P3. In particular, the vertical trajectory 28 can be configured to pass under the altitude highlighted by the symbol P1, through the point highlighted by the symbol P2, and over the altitude highlighted by the symbol P3. Moreover, the screen 3 can generate a dynamic visual feedback on a predicted trajectory associated with the guidance target, which makes it possible to have directly on the same screen 3 both a way for modifying the guidance target, for displaying the current value of the guidance target, and an indication of the effect generated on the trajectory of the aircraft by a modification of the guidance target. This can be particularly advantageous operationally, since the pilot can immediately interpret the impact of his or her guidance target modifications on the trajectory, and can do so without requiring any visual toing and froing between a control panel and a display screen.

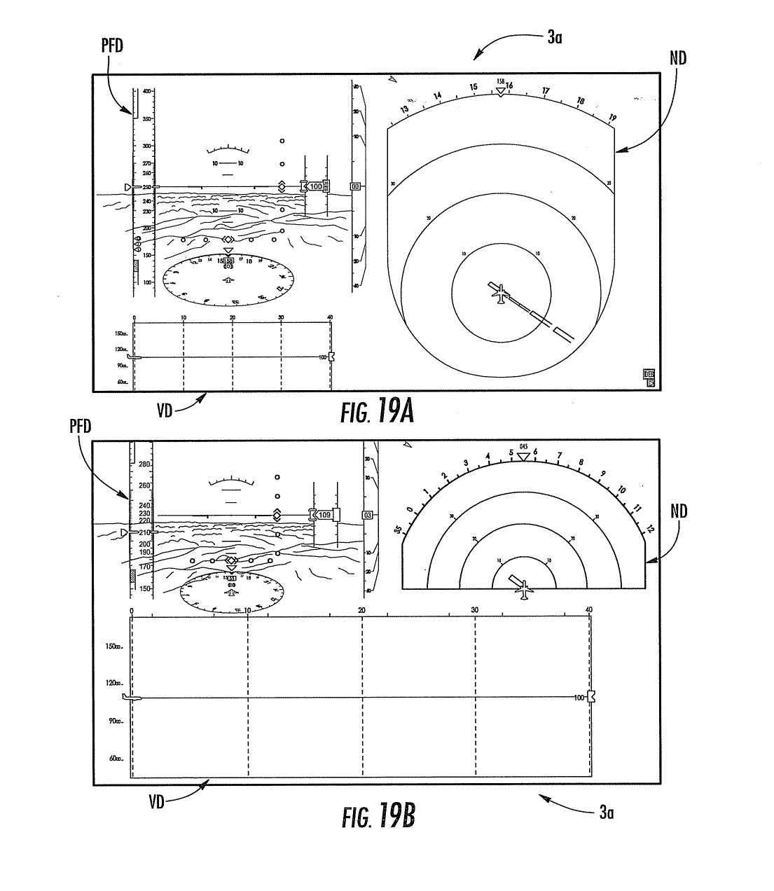

Furthermore, in the latter embodiment, screen 3 may also display, automatically, at least one characteristic point 31 of the predicted trajectory 30 (FIG. 16). As an illustration, for example, screen 3 may display characteristic points (i.e., waypoints) identifying one or more of the point of intersection of the horizontal distance (in Nm), relative to the aircraft, of the point of capture of the target altitude (as shown in FIG. 16), its predicted heading/route trajectory with the flight plan, and/or the point of intersection of its predicted heading/route trajectory with the axis of the runway used for a landing. In one particular embodiment, the interactions can be extended to the characteristic points of the display of the predicted trajectory of the preceding embodiment. Thus, the interaction element can be capable of acting on the displayed characteristic point or points of the predicted trajectory to modify them.

As an illustration, it is thus notably possible to carry out the following operations. First, on the heading presetting, it can be possible to delay the start of turn by pushing back, along the predicted trajectory for example, the representation (on the ND screen) of the point at which the taking into account of the heading presetting target begins. Similarly, on the gradient/speed presetting, it can be possible to delay the descent/climb start point by an interaction on the graphic representation of this point (e.g., on the VD screen). It can be further possible to modify the vertical speed/gradient target by an interaction on the end-of-climb/descent graphic representation.

As an illustration, as shown in FIG. 16, the aircraft can follow a vertical trajectory (plot 29) relative to a flight level FL6. Furthermore, an operator can cause a vertical trajectory (plot 30) relating to a presetting mode to appear. This trajectory can be highlighted by a different representation (for example a different color) from that of the plot 29. For instance, the plot 29 can be green and the plot 30 can be yellow. The operator can move a characteristic point 31 of the trajectory 30, as illustrated by an arrow 32, so as to act on the target altitude capture point thus modifying the vertical climb speed. The pilot can thus perform an interaction on this characteristic point 31 of the predicted trajectory 30. The new altitude target (to reach the flight level FL7 according to the trajectory 30) can be taken into account by the guidance system 4 after an engagement of a climb mode, which can be controlled by an appropriate actuation of the interaction element 8.

In addition, in yet another configuration of the present subject matter, the screen 3 can be a primary flight display PFD type, including a second heading scale 12b, a second altitude scale 22b, an airspeed indicator 42, and a vertical speed indicator 44. As with the other configurations for screen 3 discussed above, an interaction element 8 can allow integrated control of one or more of these guidance targets, for example by having the screen 3 be configured as a touch screen device or by using a separate control device 6 (e.g., an eye tracker used in combination with a secondary control device).

In another particular configuration of dialog device 1, rather than a plurality of individual screens 3 that each display one of the three guiding screens (e.g., navigation display ND (See, e.g., FIG. 2), primary flight display PFD (See, e.g., FIG. 17) and vertical display VD (See, e.g., FIG. 3)), all of the flight parameters can be displayed on a single combined screen, hereinafter referred to as a global screen 3a (See, e.g., FIG. 18), with portions of global screen 3a being configured to display guidance information in the form of one or more of a navigation display ND, a primary flight display PFD, and/or a vertical display VD.

Global screen 3a can be a tactile screen as discussed above, or it can be a conventional screen connected to one or more control devices 6 (e.g., an eye tracker combined with a second control device) that can be used to manipulate the data. In any configuration, the flight information (e.g., speed, altitude, vertical speed, heading, and/or track) displayed on one of the three guiding “screens” (i.e., portions of global screen 3a) can be linked to the information on the two other “screens”. Furthermore, each guiding screen can have at least one interaction element 8.

Specifically, for example, as to navigation display ND, it can be possible to act with the heading of the aircraft, such as is discussed above with respect to the embodiments shown in FIGS. 2 to 8. As to the vertical display VD, it can be possible to act with altitude and/or waypoints as discussed above with respect to the embodiments shown in FIGS. 9 to 16. As to the primary flight display PFD, global screen 3a can be configured to allow adjustments of the aircraft speed, altitude, vertical speed or flight path angle, and Heading or Track scale. Control over each of these elements can be accomplished through direct on the guidance target (e.g., using an interaction element 8) or on the projected trajectory of the aircraft (e.g., adjustment of characteristic points/waypoints) as discussed hereinabove. As discussed above, this direct action can for example be performed by direct contact with the screen (i.e., touch control) or via a control device 6 connected to the global screen 3a.

In addition, on the global screen 3a, the interaction element 8 associated with associated guidance targets on different displays can linked. For example, changing the position of an interaction element 8 with respect to the first altitude scale 22a on the vertical display VD can cause a corresponding change of an interaction element associated with a second altitude scale 22b on the primary flight display PFD (and reciprocally). In another example, changing the position of an interaction element 8 with respect to the first heading scale 12a on the navigation display ND can change the position of a corresponding interaction element 8 associated with a second heading scale 12b on the primary flight display PFD (and reciprocally). As described above, each of these changes can be managed through the interaction element 8.

In addition, this global screen 3a can allow further interactivity. For example, each “screen” (e.g., portions of the global screen 3a corresponding to a navigation display ND, vertical display VD, or primary flight display PFD) can be selectively magnified (i.e., enlarged compared to the others), and the scale of the other screens can be adapted accordingly. As shown in FIG. 19a, for example, the navigation display ND can be selectively sized to occupy a comparatively larger portion of the display space of global screen 3a (e.g., the right half) compared to the vertical display VD and primary flight display PFD. Where it is desired to focus on a different set of guidance targets, however, the relative sizes of the different “screens” can be adjusted. As shown in FIG. 19b, for example, the vertical display VD can be resized to occupy a comparatively larger portion of the display space of global screen 3a (e.g., the bottom half) compared to the navigation display ND and primary flight display PFD. Furthermore, the map displayed on the navigation display ND can also be moved, zoomed, etc., (e.g., in a manner similar to the interaction by a user of a smart phone).

Dialog device 1 according to the present subject matter thus enables the pilot to select guidance targets (as well as guidance modes) in the same place (screen 3 or global screen 3a) where the pilot can check and monitor the behavior of the aircraft. This avoids the visual toing and froing and a dispersion of the guidance elements, which exist on the standard dialog devices. These comments also apply to the second embodiment using a control device 6 since, in this case, the pilot can visually follow, on the screen 3, the commands produced using the control device 6 (which are likely to be located separately from the screen 3).

The present subject matter also relates to a guidance system 4 of an aircraft, namely a flight director 4A or an automatic piloting system 4B or an auto thrust system 4C, which comprises a dialog device 1 such as that mentioned above, to enable a dialog between the guidance system 4 and a pilot of the aircraft.

Moreover, in one aspect, dialog device 1 can comprise an interaction element 8 associated with each of one or more given guidance targets (e.g., speed/Mach, heading/route, altitude, vertical speed/gradient) of the guidance system 4. The use of each interaction element 8, namely one interaction element for each guidance target, on the screens 3 dedicated to the playback of the flight parameters and guidance (e.g., PFD, ND, VD), makes it possible to implement, directly on these screens 3, all the functions of a standard physical control unit (e.g., of FCU type), and therefore to dispense with such a control unit, which represents a significant saving, notably in terms of cost, weight and bulk. For example, FIGS. 20b and 20c show operation of an interaction element 8 associated with the airspeed indicator 42, FIGS. 20d and 20e show operation of an interaction element 8 associated with the second altitude scale 22b, FIGS. 20f and 20g show operation of an interaction element 8 associated with the vertical speed indicator 44, and FIGS. 20h and 20i show operation of an interaction element 8 associated with the first heading scale 12a. With respect to any of these guidance targets, interaction element 8 can be selected and selectively moved to cause changes to the value of the respective guidance target.

In addition, in one particular configuration, interaction element 8 can comprise a plurality of states which allow different actions to be implemented. The transition from one state to another of the interaction element 8 can be generated by a corresponding movement thereof. In this case, the interaction element 8 comprises states which allow at least some of the following different actions to be implemented: modifying a selected guidance target, which can be applied by guidance system 4; modifying a preset guidance target, which will be applied directly by guidance system 4 after validation; arming or engaging a capture or maintain mode for a selected guidance target (selected mode); and/or engaging a capture or maintain mode for a guidance target computed automatically in the usual manner (managed mode).

In one particular configuration, interaction element 8 thus makes it possible to control the engagement (i.e., activation) of the associated guidance mode on the defined value (so-called selected mode) or on a value computed by the system according to certain criteria (so-called managed mode), and also the arming of a guidance mode. In a particular embodiment, interaction element 8 is not displayed continuously on screen 3, but rather appears on request by placing a pointing element on the corresponding graphic object (by a direct contact or by the positioning of a cursor), as illustrated in FIG. 3.

Furthermore, each interaction element 8 can have the abovementioned states (e.g., not visible, modification directly taken into account for guidance, preset, request to arm or engage the managed mode) which can be accessed by a cursor movement, by contact in touch mode, or by eye focus when using an eye-tracking version of control device 6. The management of interaction element 8 can be such that, by default, the state of interaction element 8 is invisible (e.g., only the display of the target value is displayed in the case where a target exists). Interaction element 8 can be configured to appear, on request, by placing the cursor (or a finger 9) on the graphic object representing the value of the guidance target or the current value of the parameter. Consequently, the modification of the associated target can be effected by moving interaction element 8 along a predefined path such as for example a curve. The guidance target can then be taken into account immediately.

Alternatively, if the pilot wants to preset the guidance target (i.e., choose a value without activating it), and activate it only later (e.g., after validation of his or her request by air traffic control), the pilot can access the presetting state by locating on the interaction element 8, by selecting or grasping it, such as by simply touching it, and by moving it appropriately. For example, the pilot can move interaction element 8 backward (i.e., away from the scale or the curve of movement for the modification) so as to cause a different graphic state associated with the presetting to appear (which is highlighted by an appropriate color, for example yellow). Then, the pilot can modify the presetting value by moving the interaction element 8 along the predefined path, such as a curve for example (as for the guidance target). To actually activate a presetting, an appropriate movement of the interaction element 8, such as toward the interior this time (i.e., toward the scale, as shown in FIG. 12), can cause the overlapping of the graphic object associated with the presetting, thus validating the value for the actual guidance of the aircraft.

To engage or arm the managed mode of the axis concerned (mode for which the guidance target is computed automatically by the system according to predefined criteria), the interaction element 8 can be pushed more toward the interior of the interface giving control to the system and causing a graphic object to be covered to validate the command to appear temporarily. In a particular embodiment as shown in FIGS. 12, the releasing of the interaction element 8 can take effect at the end of travel of the movement required to validate the action. In this case, a releasing of the interaction element 8 before the end of the required movement has no effect.

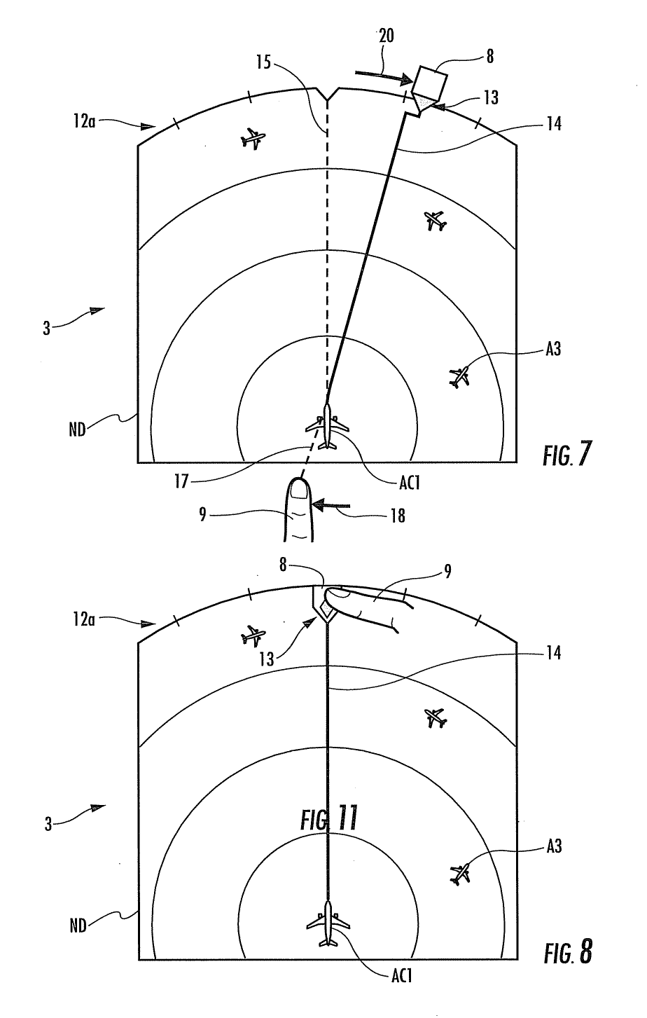

In the context of the present subject matter, the interaction element 8 can be moved by a direct action. It is, however, also possible to envisage moving the interaction element by a so-called “lever arm” effect. In the latter case, an operator interacts with the graphic object representing the guidance target (for example heading/route), not by a direct interaction on this object, but with a lever arm located diametrically opposite this target representation, along the scale, notably in heading rose form, as illustrated by a dashed line 17 in FIG. 7 (which represents the same situation as FIG. 4) on a point of which acts a finger 9 whose movement is illustrated by an arrow 18, which provokes the movement of the interaction element 8 in the direction and the way illustrated by an arrow 20.

Moreover, in a particular embodiment, dialog device 1 can comprise at least one interaction element, which is capable of controlling at least two different references (e.g., speed/Mach, heading/route, vertical speed/gradient) of a guidance target of the guidance system 4. In this case, it can be capable of controlling only one reference at a time, and the selection of one of the references to be controlled depends on the way in which the interaction element 8 is made to appear.

In the latter embodiment, the manner in which the interaction element 8 is made to appear therefore makes it possible to select the target reference. For example, by bringing the interaction element over the first heading scale 12a (See, e.g., FIG. 3), the status of the interaction element 8 making it possible to modify the heading target is made to appear, whereas a summons from the interior of the first heading scale 12a (FIG. 8 which illustrates the same situation as FIG. 3) causes the status of the interaction element 8 making it possible to select and modify a route target to appear. In this way, it is possible to switch over from a heading reference to a route reference.

The subject matter described herein can be implemented in software in combination with hardware and/or firmware. For example, the subject matter described herein may be implemented in software executed by one or more processors. In one exemplary implementation, the subject matter described herein may be implemented using a non-transitory computer readable medium having stored thereon computer executable instructions that when executed by the processor of a computer control the computer to perform steps. Exemplary computer readable media suitable for implementing the subject matter described herein can include non-transitory computer readable media such as, for example and without limitation, disk memory devices, chip memory devices, programmable logic devices, and application specific integrated circuits. In addition, a computer readable medium that implements the subject matter described herein may be located on a single device or computing platform or may be distributed across multiple devices or computing platforms.

The present subject matter can be embodied in other forms without departure from the spirit and essential characteristics thereof. The embodiments described therefore are to be considered in all respects as illustrative and not restrictive. Although the present subject matter has been described in terms of certain preferred embodiments, other embodiments that are apparent to those of ordinary skill in the art are also within the scope of the present subject matter.

1. A dialog device for an aircraft and guidance system of the aircraft, the dialog device comprising:
a global screen configured for displaying guidance information related to a navigation display, a vertical display, and/or a primary flight display;
wherein the global screen comprises at least one graphic object adapted to display an interaction element that represents a control feature associated with one or more of the navigation display, the vertical display, or the primary flight display; and
wherein the dialog device is adapted for an operator to move the interaction element to modify the control feature.

2. The dialog device of claim 1, wherein the control feature comprises of at least one guidance target of the guidance system associated with one or more of the navigation display, the vertical display, or the primary flight display.

3. The dialog device of claim 1, wherein the global screen is configured such that movement of an interaction element with respect to one of the navigation display, the vertical display, or the primary flight display causes corresponding movement of an interaction element with respect to another of the navigation display, the vertical display, or the primary flight display.

4. The dialog device of claim 1, wherein the global screen is configured such that each of the navigation display, the vertical display, and the primary flight display is selectively sizeable relative to others of the navigation display, the vertical display, and the primary flight display.

5. The dialog device of claim 1, wherein the interaction element is movable to any of a plurality of states which allow different actions to be implemented.

6. The dialog device of claim 5, wherein the interaction element is movable to one or more states which allow implementation of different actions comprising: modifying a guidance target, which is applied by the guidance system; modifying a preset guidance, target, which will be applied by the guidance system after validation; engaging a capture or maintain mode for a selected guidance target; or engaging a capture or maintain mode for a computed guidance target.

7. The dialog device of claim 5, wherein a transition from one state to another of the interaction element is generated by a corresponding movement thereof.

8. The dialog device of claim 1, wherein the dialog device is adapted for the global screen to generate a dynamic visual feedback on a predicted trajectory associated with the guidance target.

9. The dialog device of claim 8, wherein the global screen automatically displays at least one characteristic point of the predicted trajectory.

10. The dialog device of claim 9, wherein an interaction element is configured for adjusting a position of the characteristic point of the predicted trajectory.

11. The dialog device of claim 1, wherein the global screen comprises a touch screen; and
wherein the dialog device is adapted for the interaction element to be controlled by direct contact with the touch screen.

12. The dialog device of claim 1, comprising a control device linked to the global screen and configured to control the movement of a cursor on the global screen and to act on the interaction element.

13. The dialog device of claim 12, wherein the control device comprises:
an eye tracker configured to detect a zone of focus of an operator of the aircraft and to select an interaction element contained within a zone of focus; and
a secondary control device linked to the global screen and configured to selectively cause movement of the interaction element so as to modify the control feature.

14. A method for controlling a guidance system of an aircraft, the method comprising:
displaying guidance information related to each of a navigation display, a vertical display, and a primary flight display on a global screen;
selecting at least one interaction element on one of the navigation display, the vertical display, or the primary flight display, wherein the interaction element represents a control feature for a guidance system associated with one or more of the navigation display, the vertical display, or the primary flight display; and
moving the interaction element on one of the navigation display, the vertical display, or the primary flight display to modify the control feature.

15. The method of claim 14, wherein displaying guidance information comprises selectively sizing one of the navigation display, the vertical display, or the primary flight display on the global screen relative to others of the navigation display, the vertical display, and the primary flight display.

16. The method of claim 14, wherein the global screen comprises a touch screen; and
wherein selecting an interaction element comprises directly contacting the touch screen.

17. The method of claim 14, wherein selecting an interaction element comprises moving a control device linked to the global screen, the control device being configured to control the movement of a cursor on the global screen and to act on the interaction element.

18. The method of claim 17, wherein the control device comprises an eye tracker;
wherein selecting an interaction element comprises detecting a zone of focus of an operator of the aircraft and selecting an interaction element contained within the zone of focus; and
wherein moving the interaction element comprises selectively operating a secondary control device linked to the global screen.

19. The method of claim 14, wherein moving the interaction element of one of the navigation display, the vertical display, or the primary flight display causes corresponding movement of an interaction element with respect to another of the navigation display, the vertical display, or the primary flight display.

20. The method of claim 14, wherein the control feature comprises of at least one guidance target of the guidance system associated with one or more of the navigation display, the vertical display, or the primary flight display.

21. The method of claim 14, wherein moving the interaction element comprises moving the interaction element along a curve of one of the navigation display, the vertical display, or the primary flight display.

22. The method of claim 14, wherein moving the interaction element comprises moving the interaction element to any of a plurality of states which allow different actions to be implemented.

23. The method of claim 22, wherein moving the interaction element comprises moving the interaction element to one or more states which allow implementation of different actions including: modifying a guidance target, which is applied by the guidance system; modifying a preset guidance target, which will be applied by the guidance system after validation; engaging a capture or maintain mode for a selected guidance target; or engaging a capture or maintain mode for a computed guidance target.
